(19) United States
(12) Patent Application Publication
(10) Pub. No.: US 2012/0191645 A1
(43) Pub. Date: Jul. 26, 2012

(54) INFORMATION PROCESSING APPARATUS AND DATABASE SYSTEM

(75) Inventors: Yasuo Koike, Kawasaki (JP); Daisuke Shimabayashi, Kawasaki (JP); Kenji Iino, Kawasaki (JP)

(73) Assignee: FUJITSU LIMITED, KAWASAKI (JP)

(21) Appl. No.: 13/331,133

(22) Filed: Dec. 20, 2011

(30) Foreign Application Priority Data
Jan. 25, 2011 (JP) 2011-013485

(51) Int. Cl. G06F 17/30; G06F 9/46

(52) U.S. Cl. 707/610; 718/100; 707/E17.005

(57) ABSTRACT

An information processing apparatus includes an execution response unit that executes an operation command and sends results of the execution to a process execution apparatus, a first result update unit that, upon receiving a determination command when the information processing apparatus is operating normally, updates the information processing apparatus with the results of the execution sent by the execution response unit and that transmits the results of the execution to copy apparatuses, a second result update unit that, upon receiving the determination command when operation of the information processing apparatus is abnormal, transmits an abnormality notification to the copy apparatuses, and a determination transmission unit that, upon being notified of the update using the results of the execution from the copy apparatuses that have received the results of the execution transmitted from the first result update unit, notifies the process execution apparatus of the determination of the operation command.

### CROSS-REFERENCE TO RELATED APPLICATION

This application is based upon and claims the benefit of priority of the prior Japanese Patent Application No. 2011-013485, filed on Jan. 25, 2011, the entire contents of which are incorporated herein by reference.

### FIELD

The present art relates to an information processing apparatus and a database system.

### BACKGROUND

Currently, transactions need to be consistent between an application and a database as said in atomicity, consistency, isolation, and durability (ACID) properties. Therefore, the database increases the consistency and the integrity by executing a commitment process for determining the transactions. With the commitment process, it is possible to prevent abnormal termination such an abortion of a transaction, thereby increasing the reliability of the database in the transaction process.

In addition, as a method for increasing the reliability of the database in the transaction process, a method in which the database has a main-sub configuration is also used. More specifically, the main-sub configuration includes a main database that executes transactions and a sub-database obtained by copying the main database. When a commitment process is executed for a transaction, an update difference of the main database is transmitted to the sub-database to enable synchronization. If an abnormality has occurred in the main database or if an inconsistency has been generated due to execution of a transaction, the sub-database is used as the main database (for example, U.S. Pat. No. 5,640,561 and Japanese Unexamined Patent Application Publication No. H03-250257).

Once a transaction is determined by the commitment process, the transaction cannot be canceled. Therefore, in the case of distributed transactions, in which transactions are executed among a plurality of database servers, the timing at which the commitment process is executed needs to be agreed between the database servers. As a method for associating a plurality of databases, a database link or the like is used.

As a method for executing a commitment process for such distributed transactions, a method called “two-phase commitment control” has been disclosed. In the two-phase commitment control, a commitment process is executed in two phases, namely a commitment requirement phase and a commitment phase.

In the first phase, namely the commitment requirement phase, an instruction for shifting to a commitment stand-by state, which is a state in which a commitment process can be executed, is transmitted to the transaction of each database server and results of the instruction are received. In the second phase, namely the commitment phase, an instruction for executing a commitment process is transmitted to each transaction when the transaction of each database server has been shifted to the commitment stand-by state. It is to be noted that, in the commitment phase, an instruction of rollback is transmitted to each transaction if any transaction is not shifted to the commitment stand-by state.

### SUMMARY

According to an aspect of an embodiment, an information processing apparatus has an execution response unit that, upon receiving an operation command from a process execution apparatus that executes various processes, executes the operation command and that sends results of the execution back to the process execution apparatus, a first result update unit that, upon receiving a determination command for determining the operation command when the information processing apparatus is operating normally, updates the information processing apparatus with the results of the execution sent by the execution response unit and that transmits the results of the execution to copy apparatuses obtained by copying the information processing apparatus, a second result update unit that, upon receiving the determination command transmitted from the process execution apparatus when operation of the information processing apparatus is abnormal, transmits an abnormality notification indicating that the operation of the information processing apparatus is abnormal to the copy apparatuses, and a determination transmission unit that, upon being notified of the update using the results of the execution from the copy apparatuses that have received the results of the execution transmitted from the first result update unit, notifies the process execution apparatus of the determination of the operation command.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the overall configuration of a database system according to a first embodiment.

FIG. 2 is a block diagram illustrating the configuration of an application server according to a second embodiment.

FIG. 3 is a diagram illustrating an example of information stored in a multicast storage section.

FIG. 4 is a block diagram illustrating the configuration of a database (DB) server according to the second embodiment.

FIG. 5 is a diagram illustrating an example of a data structure for judging servers that are earlier than a server that includes a main-sub relationship storage unit in the promotion order stored in the main-sub relationship storage unit.

FIG. 6 is a diagram illustrating an example of a data structure for judging servers that are later than the server that includes the main-sub relationship storage unit in the promotion order stored in the main-sub relationship storage unit.

FIG. 7 is a diagram illustrating an example of information stored in an operation command storage unit.

FIG. 8 is a diagram illustrating an example of information stored in an operation result log storage unit.

FIG. 9 is a diagram illustrating an example of an update log transmitted from a main DB server to a sub-DB server.

FIGS. 10A and 10B are sequence diagrams illustrating the flow of a commitment process according to the second embodiment.

FIGS. 11A and 11B are sequence diagrams illustrating the flow of processing at a time when an abnormality has occurred during the commitment process according to the second embodiment.

FIGS. 12A and 12B are sequence diagrams illustrating the flow of the commitment process according to the second embodiment when a communication abnormality has occurred.

FIG. 13 is a sequence diagram illustrating the flow of processing in two-phase commitment control.

FIG. 14 is a diagram illustrating an example of a computer system that executes application server control programs.

FIG. 15 is a diagram illustrating an example of a computer system that executes database server control programs.

### DESCRIPTION OF EMBODIMENTS

In the case of the above-described two-phase commitment control in the related art, there is a problem in that an operation command such as a transaction cannot be determined in one phase.

For example, in the case of the two-phase commitment control, if any transaction included in distributed transactions fails, all the distributed transactions are rolled back. Therefore, in order to complete a commitment process for the distributed transactions, the commitment process needs to be repeatedly executed until all the transactions are successfully completed. That is, in the case of the two-phase commitment control, a commitment phase cannot be entered until it is confirmed in a commitment requirement phase that all the transactions have been shifted to a state in which the commitment process is possible. Accordingly, there is a problem in that the performance is impaired since the number of communications in the distributed transactions is twice that in normal transactions. In addition, if any transaction included in the distributed transactions fails, all the transactions are rolled back. If a server crash or the like occurs during execution of this sequential operation, a database enters an in-doubt state, and therefore an application needs to check results when the server has recovered.

Embodiments of an information processing apparatus and a database system disclosed herein will be described hereinafter in detail with reference to the drawings. It is to be understood that the embodiments do not limit the present invention.

### First Embodiment

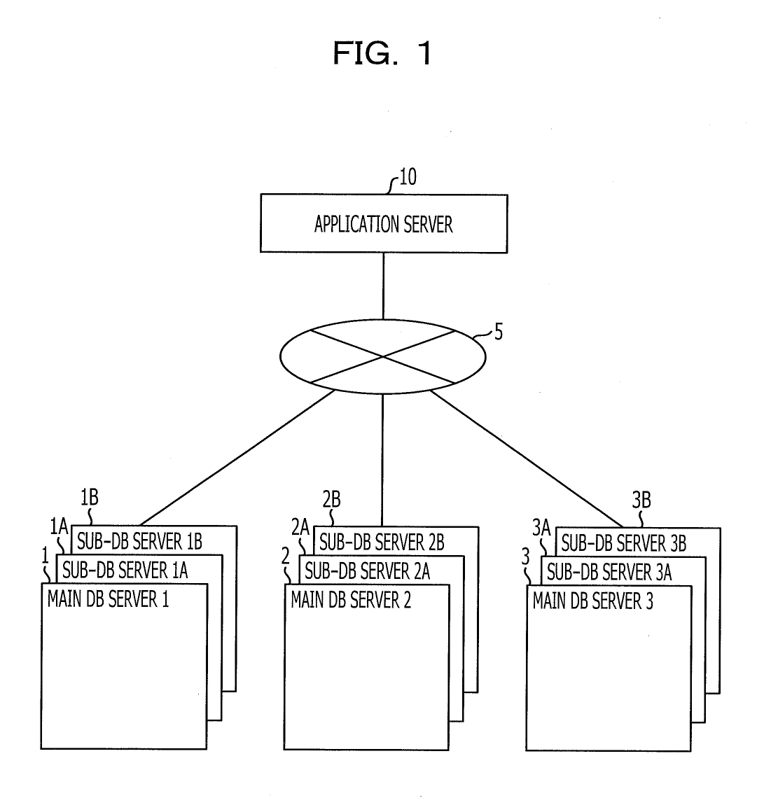

FIG. 1 is a diagram illustrating the overall configuration of a database system according to a first embodiment. As illustrated in FIG. 1, the database system has an application server 10, a main DB server 1, a sub-DB server 1A, a sub-DB server 1B, a main DB server 2, a sub-DB server 2A, a sub-DB server 2B, a main DB server 3, a sub-DB server 3A, and a sub-DB server 3B. In this database system, the application server 10 and each DB server are connected by, for example, a network 5 such as the Internet or a local area network (LAN) in such a way as to enable communication with each other.

The application server 10 is a server apparatus that executes and controls applications for executing a transaction for each DB server and distributed transactions for a plurality of DB servers.

The main DB server 1 is a database server apparatus that stores data to be processed by the application server 10. The sub-DB servers 1A and 1B are database server apparatuses that copy and store the data stored in the main DB server 1. The main DB server 1 and the sub-DB server 1A or the sub- DB server 1B correspond to an apparatus in use and a stand-by apparatus, respectively, in a redundant configuration. That is, if an abnormality has occurred in the main DB server 1, the sub-DB server 1A serves as the main DB server and continues the process even after the occurrence of the abnormality.

The relationships between the main DB server 2 and both the sub- DB server 2A and the sub-DB server 2B and the relationships between the main DB server 3 and both the sub-DB server 3A and the sub-DB server 3B are the same as those between the main DB server 1 and both the sub-DB server 1A and the sub-DB server 1B, and therefore description thereof is omitted herein.

When transmitting an operation command to the main DB server 1 in such a condition, the application server 10 transmits the operation command to the main DB server 1 and the sub-DB servers 1A and 1B using multicast. Similarly, when transmitting an operation command to the main DB server 2 in such a condition, the application server 10 transmits the operation command to the main DB server 2 and the sub-DB servers 2A and 2B using multicast. When determining the operation command, the application server 10 transmits a determination command for determining the operation command to each database server involved in the transaction using multicast.

Upon receiving the operation command from the application server 10, the main DB servers 1, 2, and 3 execute the operation command and send results of the execution back to the application server 10. In addition, upon receiving the determination command when the main DB servers 1, 2, and 3 are operating normally, the main DB servers 1, 2, and 3 update themselves with the results of the execution and transmit the results of the execution to each sub-DB server. Thereafter, when each sub-DB server has notified the main DB servers 1, 2, and 3 of update thereof with the results of the execution, the main DB servers 1, 2, and 3 notify the application server 10 of the determination of the operation command. On the other hand, upon receiving the determination command when the operation of the main DB servers 1, 2, and 3 is abnormal, the main DB servers 1, 2, and 3 transmit an abnormality notification to each sub-DB server.

Upon receiving an operation command from the application server 10, the sub-DB servers 1A and 1B, the sub-DB servers 2A and 2B, and the sub-DB servers 3A and 3B execute the operation command and generate results of the execution. Next, upon receiving results of execution from each main DB server, the sub-DB servers 1A and 1B, the sub-DB servers 2A and 2B, and the sub-DB servers 3A and 3B discard the results of the execution generated thereby and update themselves with the received results of the execution. Thereafter, the sub-DB servers 1A and 1B, the sub-DB servers 2A and 2B, and the sub-DB servers 3A and 3B notify each main DB server of the update using the results of the execution. On the other hand, upon receiving an abnormality notification from each main DB server, the sub-DB server 1A, the sub-DB server 2A, and the sub-DB server 3A update themselves with the results of the execution generated thereby. Thereafter, the sub-DB server 1A, the sub-DB server 2A, and the sub-DB server 3A transmit the results of the execution to the sub-DB server 1B, the sub-DB server 2B, and the sub-DB server 3B. The application server 10 is then notified of the update using the results of the execution.

As described above, in the database system illustrated in FIG. 1, a piece of data is shared by a plurality of servers, which include main and sub-DB servers, as copied data, and a database operation command is transmitted to the plurality of servers, which then execute processing independently. If an abnormality occurs in a main DB server during the commitment process, the database system officially adopts results of processing executed by a sub-DB server in order to continue the processing and complete the commitment process. That is, unlike the two-phase commitment control, since the commitment process is always completed normally, a phase in which whether or not the commitment process is possible is checked becomes unnecessary. As a result, an operation command such as a transaction can be determined in one phase.

### Second Embodiment

Next, an example of an application server and a DB server disclosed in this embodiment will be described. In the second embodiment, the configurations of the application server and the DB server, the flow of processing, and advantageous effects produced by the second embodiment will be described in this order.

Configuration of Application Server

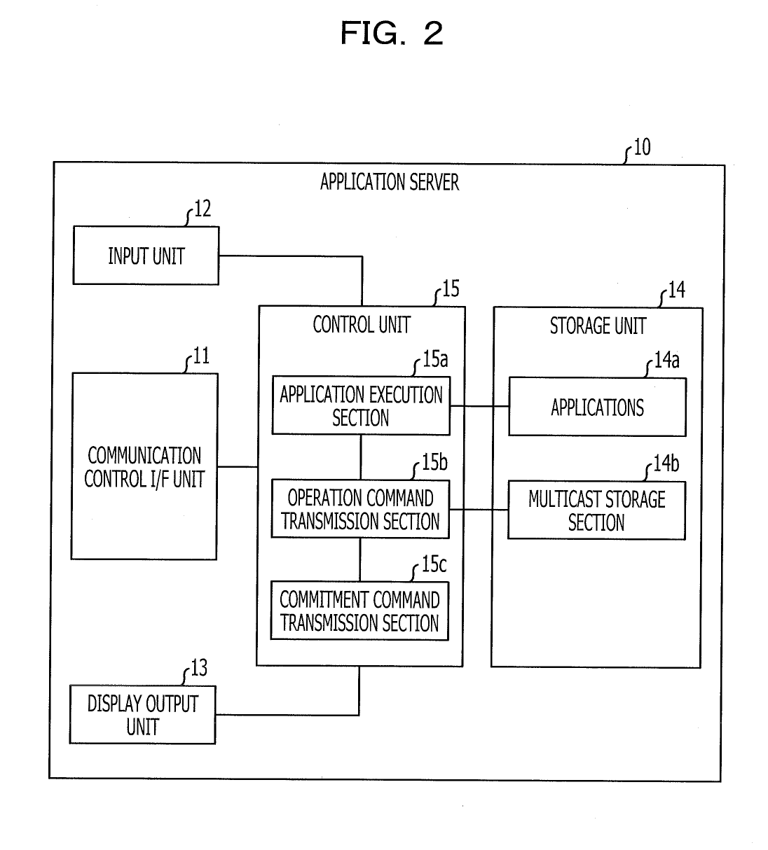

FIG. 2 is a block diagram illustrating the configuration of the application server according to the second embodiment. As illustrated in FIG. 2, an application server 10 has a communication control interface (I/F) unit 11, an input unit 12, a display output unit 13, a storage unit 14, and a control unit 15.

The communication control I/F unit 11 is an interface that controls communication between DB servers. For example, the communication control I/F unit 11 transmits a transaction and a commitment command to each DB server. In addition, the communication control I/F unit 11 receives results of execution of an operation command and results of a commitment process from each DB server.

The input unit 12 is, for example, a keyboard, a mouse, or the like. The input unit 12 receives content of a transaction, an instruction for beginning the transaction, an instruction for executing a commitment process for the transaction, and the like from an administrator or the like and outputs the content of a transaction, the instruction for beginning the transaction, the instruction for executing a commitment process for the transaction, and the like to the control unit 15. The display output unit 13 is, for example, a monitor, a speaker, or the like, and displays results of execution of a transaction, results of a commitment process, and the like.

The storage unit 14 is a storage apparatus such as a semiconductor device or a hard disk that stores programs to be executed by the control unit 15 and various pieces of data and includes, for example, applications 14a and a multicast storage section 14b.

The applications 14a are software to be read and executed by an application execution section 15a of the control unit 15. When executed by the application execution section 15a, the applications 14a execute transactions in which various processes such as update and reading of data are executed.

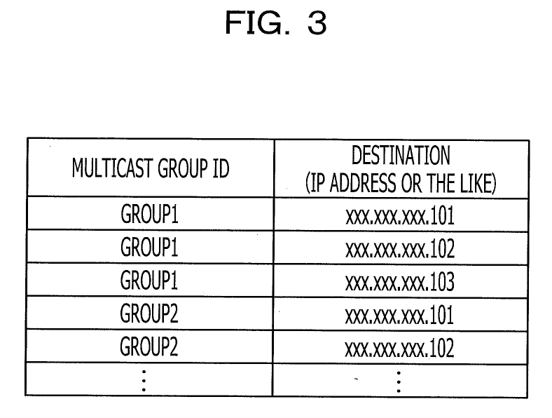

The multicast storage section 14b stores destinations of transactions transmitted from the application server 10. FIG. 3 is a diagram illustrating an example of information stored in the multicast storage section 14b. As illustrated in FIG. 3, the multicast storage section 14b stores multicast group IDs and destinations. The multicast group IDs to be stored are identifiers indicating groups to which transactions are transmitted using multicast, and the destinations are Internet Protocol (IP) addresses of the destinations or the like.

For example, FIG. 3 illustrates a case in which “xxx.xxx.xxx.101”, “xxx.xxx.xxx.102”, and “xxx.xxx.xxx.103” belong to a multicast group ID “Group 1”. In addition, “xxx.xxx.xxx.101” and “xxx.xxx.xxx.102” belong to a multicast group ID “Group 2”. It is to be noted that the strings of characters and numbers illustrated in FIG. 3 have no particular meanings and any character and number may be set.

The control unit 15 is a processing unit that transmits a request for executing a transaction and a request for executing a commitment process. The control unit 15 is, for example, an electronic circuit such as a central processing unit (CPU). The control unit 15 may be realized by middleware or the like. Such a control unit 15 includes the application execution section 15a, an operation command transmission section 15b, and a commitment command transmission section 15c.

The application execution section 15a executes an application to issue a transaction. For example, upon receiving a request for executing an application from the input unit 12, the application execution section 15a reads a corresponding application 14a from the storage unit 14. The application execution section 15a then executes the read application 14a. The application 14a executed as described above requests the operation command transmission section 15b to execute various transactions such as distributed transactions.

The operation command transmission section 15b transmits, using multicast, an operation command for operating various pieces of data to a main DB server that stores the various pieces of data and sub-DB servers that are obtained by copying the main DB server. For example, the operation command transmission section 15b receives a request for executing distributed transactions from an application executed by the application execution section 15a. The operation command transmission section 15b then identifies, from the multicast storage section 14b, destinations corresponding to a multicast group ID included in the request for executing distributed transactions. Thereafter, the operation command transmission section 15b transmits a command for executing distributed transactions to destinations that have been identified.

For example, in the case of FIG. 1, the operation command transmission section 15b transmits, using multicast, a command for executing Transaction A in which data of Record A is set to 1 to the main DB server 1, the sub-DB server 1A, and the sub-DB server 1B. Similarly, the operation command transmission section 15b transmits, using multicast, a command for executing Transaction B in which data of Record B is set to 2 to the main DB server 2, the sub-DB server 2A, and the sub-DB server 2B.

When determining an operation command transmitted by the operation command transmission section 15b, the commitment command transmission section 15c transmits, using multicast, a commitment command for determining an operation command to a main DB server and sub-DV servers. For example, the commitment command transmission section 15c receives results of execution of the operation command transmitted by the operation command transmission section 15b from the main DB server. The commitment command transmission section 15c then transmits a commitment command for determining the executed transaction to the main DB server and the sub-DB servers.

For example, in the case of FIG. 1, the commitment command transmission section 15c receives results of the execution of Transaction A from the main DB server 1. The commitment command transmission section 15c then transmits, using multicast, a commitment command for determining Transaction A to the main DB server 1, the sub-DB server 1A, and the sub-DB server 1B. In addition, the commitment command transmission section 15c receives results of the execution of Transaction B from the main DB server 2. The commitment command transmission section 15c then transmits, using multicast, a commitment command for determining Transaction B to the main DB server 2, the sub-DB server 2A, and the sub-DB server 2B.

Configuration of DB Server

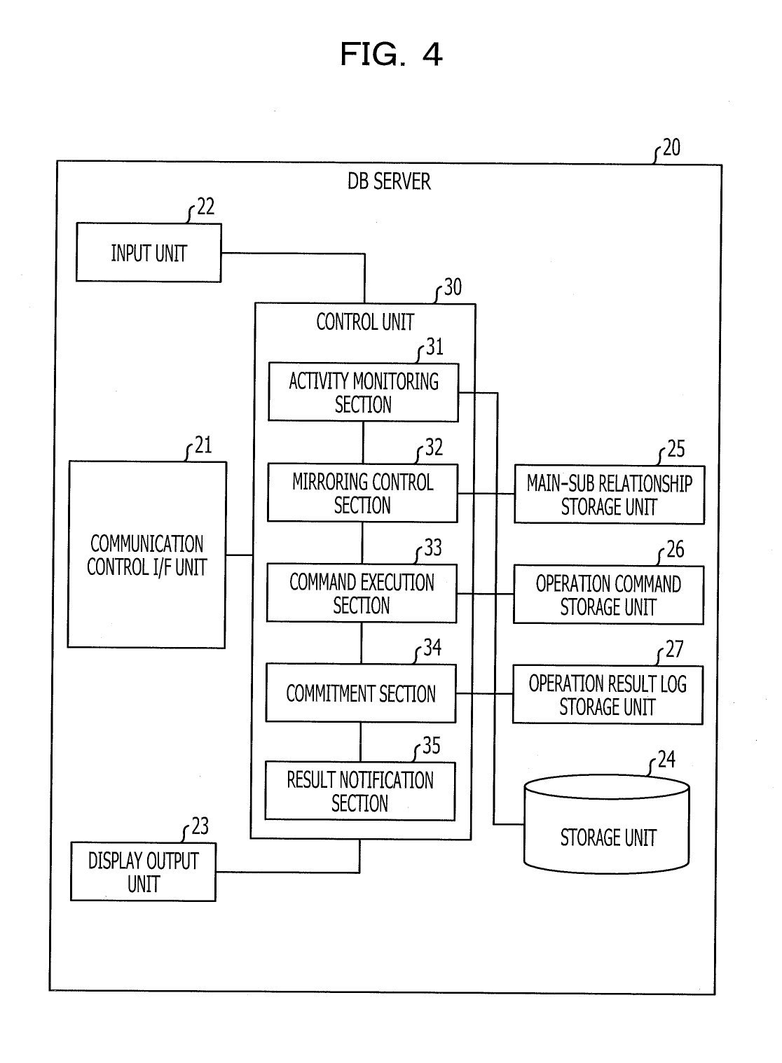

FIG. 4 is a block diagram illustrating the configuration of the DB server according to the second embodiment. Since the main DB server and the sub-DB servers have the same functions, the DB server that will be described represents both the main DB server and the sub-DB servers. As illustrated in FIG. 4, a DB server 20 has a communication control I/F unit 21, an input unit 22, a display output unit 23, a storage unit 24, a main-sub relationship storage unit 25, an operation command storage unit 26, an operation result log storage unit 27, and a control unit 30.

The communication control I/F unit 21 is an interface that controls communication with other DB servers and the application server 10. For example, the communication control I/F unit 21 receives a command for executing a transaction and a commitment command from the application server 10. In addition, the communication control I/F unit 21 transmits results of execution of a transaction and results of a commitment process to the application server 10.

The input unit 22 is, for example, a keyboard, a mouse, or the like. The input unit 22 receives operations performed by the administrator on the storage unit 24, such as various execution commands and a main-sub switching instruction, and outputs the operations to the control unit 30. The display output unit 23 is, for example, a monitor, a speaker, or the like, and displays results of execution of a transaction and results of a commitment process.

The storage unit 24 is a database that stores data to be operated by the application server 10, that is, data to be executed in a transaction. The storage unit 24 is a storage apparatus such as, for example, a semiconductor device or a hard disk.

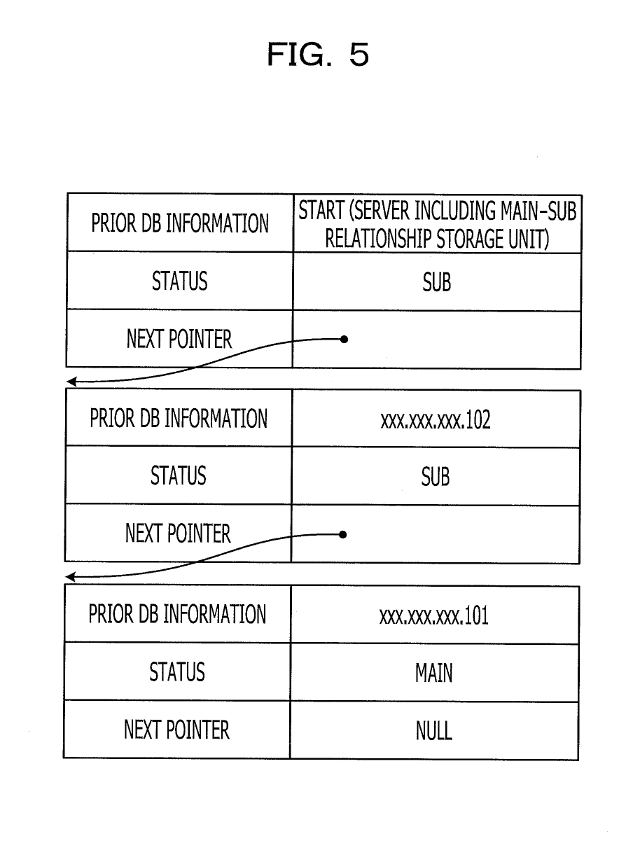

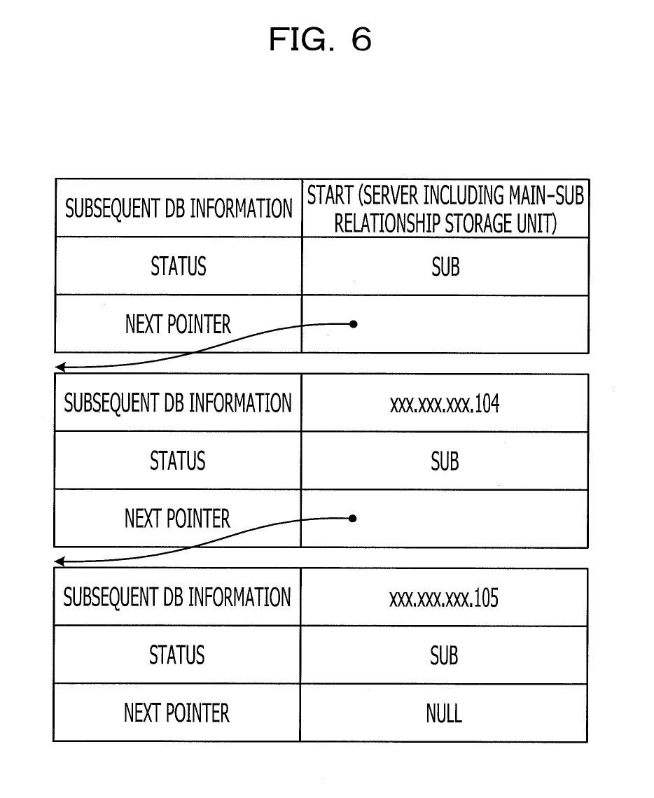

The main-sub relationship storage unit 25 stores information to be used to judge whether a server that includes the main-sub relationship storage unit 25 is a main DB server or a sub-DB server. FIG. 5 is a diagram illustrating an example of a data structure for judging servers that are earlier than the server that includes the main-sub relationship storage unit 25 in the promotion order stored in the main-sub relationship storage unit 25. FIG. 6 is a diagram illustrating an example of a data structure for judging servers that are later than the server that includes the main-sub relationship storage unit 25 in the promotion order stored in the main-sub relationship storage unit 25. It is to be noted that the strings of characters and numbers illustrated in FIGS. 5 and 6 have no particular meanings and any character and number may be set.

As illustrated in FIGS. 5 and 6, the main-sub relationship storage unit 25 associates “Prior DB information”, “Status”, and “Next pointer” with one another and stores “DB information”, “Status”, and “Next pointer”. “Prior DB information” illustrated in FIG. 5 is information indicating a DB server and “Status” is information indicating whether the DB server indicated by “Prior DB information” is a main DB server or a sub-DB server. “Next pointer” is a pointer indicating information regarding a DB server that is earlier than the DB server indicated by “Prior DB information” in the promotion order.

In addition, “Subsequent DB information” illustrated in FIG. 6 is information indicating a DB server and “Status” is information indicating whether the DB server indicated by “Subsequent DB information” is a main DB server or a sub-DB server. “Next pointer” is a pointer indicating information regarding a DB server that is later than the DB server indicated by “Subsequent DB information” in the promotion order.

In the case of FIG. 5, a server having the IP address “xxx.xxx.xxx.101” is the main DB server. A DB server having the IP address “xxx.xxx.xxx.102”, which is currently a sub-DB server, is a DB server to be promoted to the main DB server if the DB server having the IP address “xxx.xxx.xxx.101” becomes abnormal. In addition, a DB server having the IP address “xxx.xxx.xxx.103”, which is currently a sub-DB server, is a DB server to be promoted to the main DB server if the DB server having the IP address “xxx.xxx.xxx.102” that has been promoted to the main DB server becomes abnormal. The server having the IP address “xxx.xxx.xxx.103” is the DB server 20, which is the server that includes the main-sub relationship storage unit 25.

In the case of FIG. 6, a DB server having the IP address “xxx.xxx.xxx.104”, which is currently a sub-DB server, is a DB server to be promoted to the main DB server if the DB server having the IP address “xxx.xxx.xxx.103”, which is the server that includes the main-sub relationship storage unit 25, becomes abnormal after being promoted to the main DB server. A DB server having the IP address “xxx.xxx.xxx.105”, which is currently a sub-DB server, is a DB server to be promoted to the main DB server if the DB server having the IP address “xxx.xxx.xxx.104” that has been promoted to the main DB server becomes abnormal.

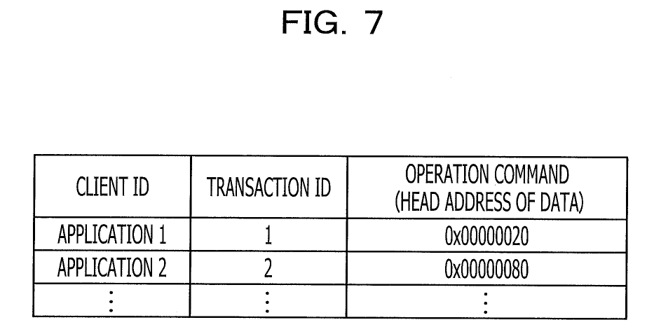

Referring back to FIG. 4, the operation command storage unit 26 stores distributed transactions received from the application server 10. FIG. 7 is a diagram illustrating an example of information stored in the operation command storage unit 26. As illustrated in FIG. 7, the operation command storage unit 26 associates “Client ID”, “Transaction ID”, and “Operation command” with one another and stores “Client ID”, “Transaction ID”, and “Operation command”. It is to be noted that the strings of characters and numbers illustrated in FIG. 7 have no particular meanings and any character and number may be set.

“Client ID” to be stored here is information indicating an apparatus that has issued an operation command such as distributed transactions. “Transaction ID” is an identifier that is given by the application server 10 or a DB server and that uniquely identifies an operation command such as a transaction. “Operation command” indicates a head address of data (structure) that includes information to be used for an operation.

In the case of FIG. 7, the transaction ID of a transaction is 1 and operation information data indicated by an address (0x00000020) of an operation command has been received from Application 1. In addition, the transaction ID of another transaction is 2 and operation information data indicated by an address (0x00000080) of an operation command has been received from Application 2.

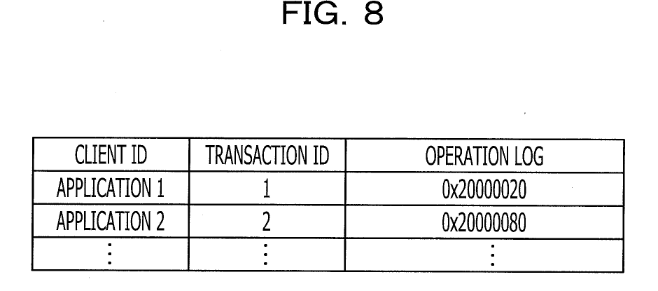

The operation result log storage unit 27 is a storage apparatus such as a semiconductor device or a hard disk that stores results of execution of a transaction. FIG. 8 is a diagram illustrating an example of information stored in the operation result log storage unit 27. As illustrated in FIG. 8, the operation result log storage unit 27 associates “Client ID”, “Transaction ID”, and “Operation log” with one another and stores “Client ID”, “Transaction ID”, and “Operation log”. It is to be noted that the strings of characters and numbers illustrated in FIG. 8 have no particular meanings and any character and number may be set.

“Client ID” to be stored here is information indicating an apparatus that has issued an operation command such as distributed transactions. “Transaction ID” is an identifier that uniquely identifies an executed operation command such as a transaction. “Operation log” is a temporary storage address of an execution result log of a transaction. It is to be noted that the operation log is not limited to address information and may be data itself. That is, the setting of the operation log may be arbitrarily changed in accordance with the type of DB to be used by a server, such as an in-memory DB or a relational database (RDB).

In the case of FIG. 8, a piece of data has obtained the value “0x20000020” of the address as a result of execution of a transaction that has been received from Application 1 and whose transaction ID is 1. In addition, another piece of data has obtained the value “0x20000080” of the address as a result of execution of a transaction that has been received from Application 2 and whose transaction ID is 2.

The control unit 30 is a processing unit that executes a transaction and a commitment process. The control unit 30 is, for example, an electronic circuit such as a CPU. In addition, the control unit 30 may be realized by middleware or the like. Such a control unit 30 has an activity monitoring section 31, a mirroring control section 32, a command execution section 33, a commitment section 34, and a result notification section 35.

The activity monitoring section 31 executes activity monitoring of each DB server connected to a server that includes the activity monitoring section 31 using ping, Simple Network Management Protocol (SNMP), or the like. When a DB server in which an abnormality has occurred has been detected, the activity monitoring section 31 notifies other sections of the control unit 30 of the detection of the abnormality. For example, in the case of FIG. 1, an activity monitoring section 31 of the main DB server 1 performs activity monitoring of the sub-DB server 1A and the sub-DB server 1B. In addition, an activity monitoring section 31 of the sub-DB server 1A performs activity monitoring of the main DB server 1 and the sub-DB server 1B. An activity monitoring section 31 of the sub-DB server 1B performs activity monitoring of the main DB server 1 and the sub-DB server 1A.

The mirroring control section 32 refers to the main-sub relationship storage unit 25 to judge whether a server that includes the mirroring control section 32 is a main DB server or a sub-DB server, and performs a process for copying data. For example, in the case of FIG. 5 or 6, since “Status” of the server that includes the mirroring control section 32 is “Sub”, the mirroring control section 32 judges that the server is operating as a sub-DB server. In addition, the command execution section 33, the commitment section 34, and the result notification section 35, which will be described later, perform different types of control depending on whether the server is a main DB server or a sub-DB server. Therefore, with respect to the command execution section 33, the commitment section 34, and the result notification section 35, both a case in which the server operates as a main DB server and a case in which the server operates as a sub-DB server will be described.

Upon receiving an operation command from the application server 10, the command execution section 33 executes the operation command and sends results of the execution back to the application server 10.

When Server is Main DB Server

For example, upon receiving a transaction from the application server 10, the command execution section 33 stores information regarding the received transaction in the operation command storage unit 26. The command execution section 33 then executes the received transaction and stores results of the execution in the operation result log storage unit 27. In addition, the command execution section 33 notifies the application server 10 of the execution of the received transaction.

When Server is Sub-DB Server

For example, upon receiving a transaction from the application server 10, the command execution section 33 stores information regarding the received transaction in the operation command storage unit 26. The command execution section 33 then executes the received transaction and stores results of the execution in the operation result log storage unit 27.

Referring back to FIG. 4, upon receiving a commitment command for determining an operation command from the application server 10, the commitment section 34 performs a commitment process on the operation command.

When Server is Main DB Server

For example, upon receiving a commitment command for executing a commitment process on a transaction transmitted from the application server 10 when a server that includes the commitment section 34 is operating normally, the commitment section 34 updates the server with results of execution sent back from the command execution section 33. The commitment section 34 then transmits the results of the execution to each sub-DB server.

For example, suppose that the commitment section 34 has received a commitment command whose transaction ID is 1 from the application server 10 when the server that includes the commitment section 34 is operating normally. In this case, the commitment section 34 extracts an operation command that is stored in the operation command storage unit 26 and whose transaction ID is 1 and an operation log that is stored in the operation result log storage unit 27 and whose transaction ID is 1. Thereafter, the commitment section 34 inputs the value of “Operation log” in the operation log to a position according to operation information indicated by “Address pointer” on the storage unit 24. The commitment section 34 then transmits an update log indicating an updated log, that is, the input operation log, to each sub-DB server.

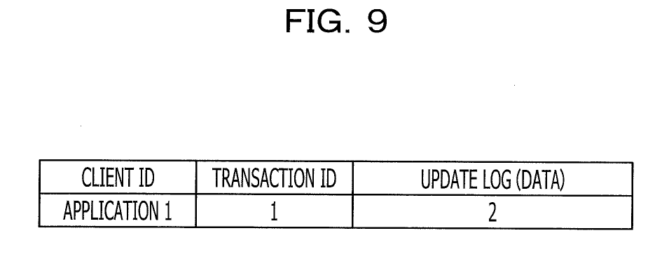

Examples of an update log to be transmitted by the commitment section 34 include an operation log illustrated in FIG. 9. FIG. 9 is a diagram illustrating an example of an update log transmitted from a main DB server to each DB server. As illustrated in FIG. 9 in an update log, “Client ID”, “Transaction ID” and “Update log” are associated with one another. “Client ID” is information indicating an apparatus that has issued a transaction to be subjected to a commitment process. “Transaction ID” is an identifier that uniquely identifies the transaction to be subjected to a commitment process or the like. “Update log” is results of execution to be subjected to a commitment process. That is, in the case of FIG. 9, data is updated in such a way as to be 2 and subjected to a commitment process in a transaction that has been issued from Application 1 and whose transaction ID is 1.

In addition, upon receiving a commitment command transmitted from the application server 10 when the operation of the server that includes the commitment section 34 is abnormal, the commitment section 34 transmits an abnormality notification indicating that the operation of the server is abnormal to each sub-DB server. For example, after receiving a commitment command whose transaction ID is 1 from the application server 10, the commitment section 34 detects occurrence of an abnormality. In this case, since the server that includes the commitment section 34 cannot execute a commitment process, the commitment section 34 transmits an abnormality notification indicating that the operation of the server is abnormal to each sub-DB server. In the case of FIG. 1, a commitment section 34 of the main DB server 1 transmits an abnormality notification to the sub-DB server 1A and the sub-DB server 1B.

When Server is Sub-DB Server

For example, upon receiving, from the main DB server, results of execution generated by a main DB server, from which the server that includes the commitment section 34 has been copied, the commitment section 34 discards results of execution generated by the server that includes the commitment section 34 and updates the server that includes the commitment section 34 with the received results of execution. In addition, upon receiving an abnormality notification indicating that the operation of the main DB server is abnormal from the main DB server, the commitment section 34 updates the server that includes the commitment section 34 with the results of the execution generated by the server that includes the commitment section 34.

For example, upon receiving the update log illustrated in FIG. 9 from the main DB server, the commitment section 34 judges that the received update log is an official result. Therefore, with respect to the transaction that has been issued from Application 1 and whose transaction ID is 1, the commitment section 34 updates a position specified by operation information indicated by a corresponding address pointer on the storage unit 24 of the server that includes commitment section 34 with data indicated by an operation log. The commitment section 34 then deletes information in which Application 1 and the transaction ID of 1 have been associated in the operation result log storage unit 27 and the operation command storage unit 26 of the server that includes the commitment section 34.

Upon receiving an abnormality notification from the main DB server, the commitment section 34 extracts “Client ID=Application 1” and “Transaction ID=1” from a commitment command received from the application server 10. The commitment section 34 then identifies an operation command corresponding to the extracted “Application 1” and “Transaction ID=1” from the operation command storage unit 26 and identifies a corresponding operation log from the operation result log storage unit 27. Thereafter, the commitment section 34 updates data stored in a position of operation information indicated by “Address pointer” of the identified operation command with data of the identified operation log. In addition, the commitment section 34 deletes information in which “Application 1” and “Transaction ID=1” have been associated in the operation result log storage unit 27 and the operation command storage unit 26 of the server that includes the commitment section 34. At this time, if an operation log of another application for a commitment target record is left in a sub-DB server, an update log is created for a record of new data.

Referring back to FIG. 4, the result notification section 35 notifies the application server 10 of termination of a commitment process for a transaction.

When Server is Main DB Server

For example, upon being notified of update using results of execution from each sub-DB server to which the results of execution have been transmitted from the commitment section 34, the result notification section 35 notifies the application server 10 of termination of a commitment process. More specifically, the result notification section 35 updates the storage unit 24 of a server that includes the result notification section 35 with results of execution generated by the server that includes the result notification section 35, the server being the main DB server. Furthermore, the result notification section 35 receives a notification indicating that a storage unit 24 of each sub-DB server has been updated with the results of execution generated by the server that includes the result notification section 35, the server being the main DB server. That is, when the server that includes the result notification section 35 and each sub-DB server have been updated with the results of execution generated by the server that includes the result notification section 35, the result notification section 35 notifies the application server 10 of termination of a commitment process.

When Server is Sub-DB Server

In addition, when update using results of execution received from the main DB server has been completed, the result notification section 35 notifies the main DB server of the completion of the update using the results of the execution. In addition, when update using results of execution generated by the server that includes the result notification section 35 has been completed, the result notification section 35 notifies the application server 10 of the completion of the commitment process.

That is, when the main DB server is operating normally, the result notification section 35 notifies the main DB server of results of the commitment process. When the main DB server is not operating normally, the result notification section 35, instead of the main DB server, transmits a notification of the completion of the commitment process to the application server 10. It is to be noted that a sub-DB server issues a notification of completion of a copy process after the update of data in order to ensure that the data is the same as that included in the main DB server, but, when a plurality of sub-DB server are provided, second and subsequent sub-DB servers may asynchronously perform update in consideration to the performance.

Flow of Processing

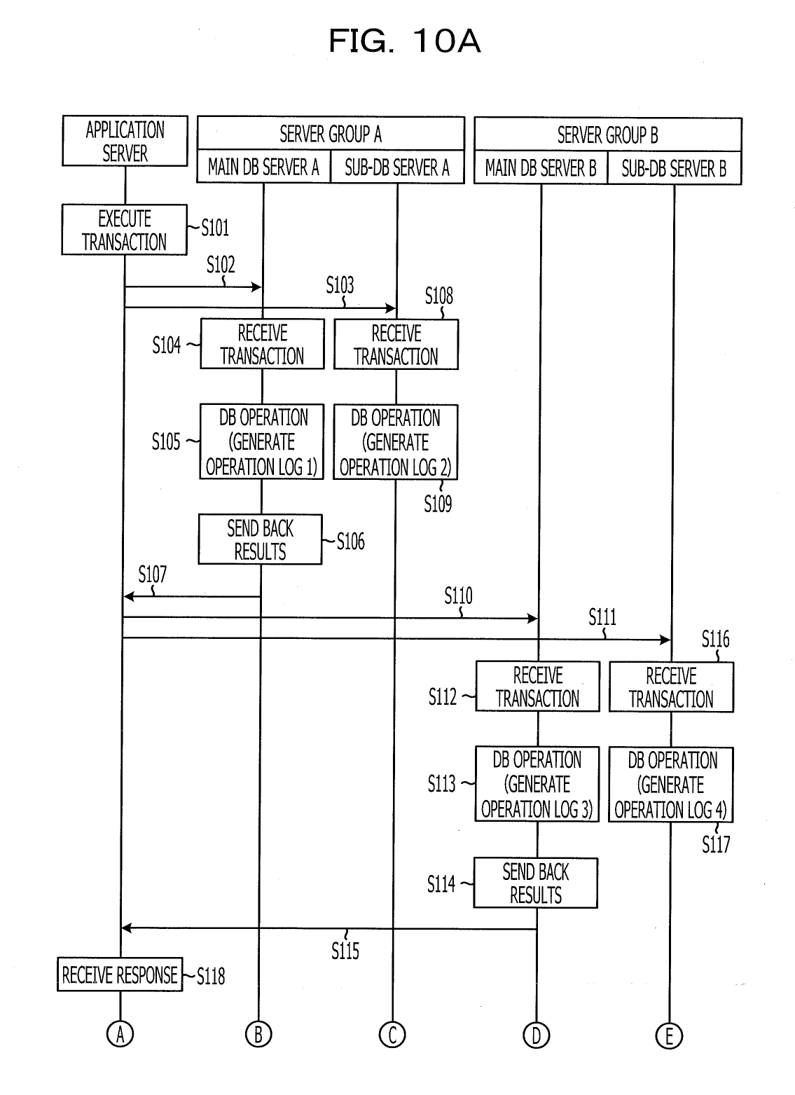

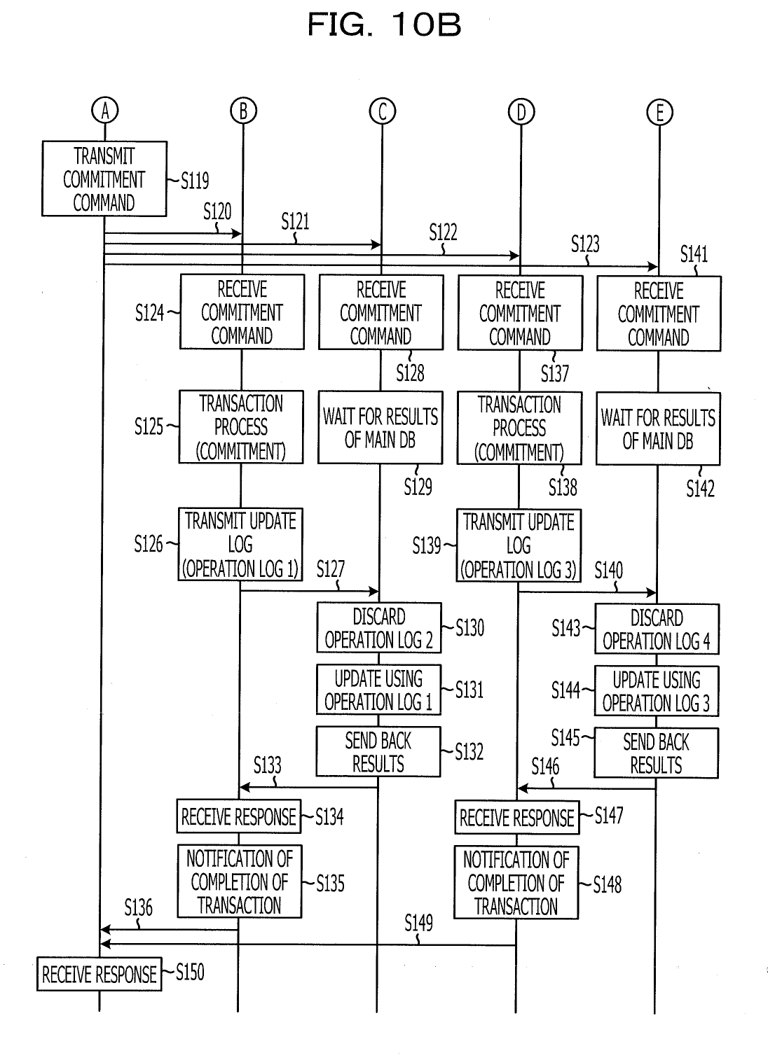

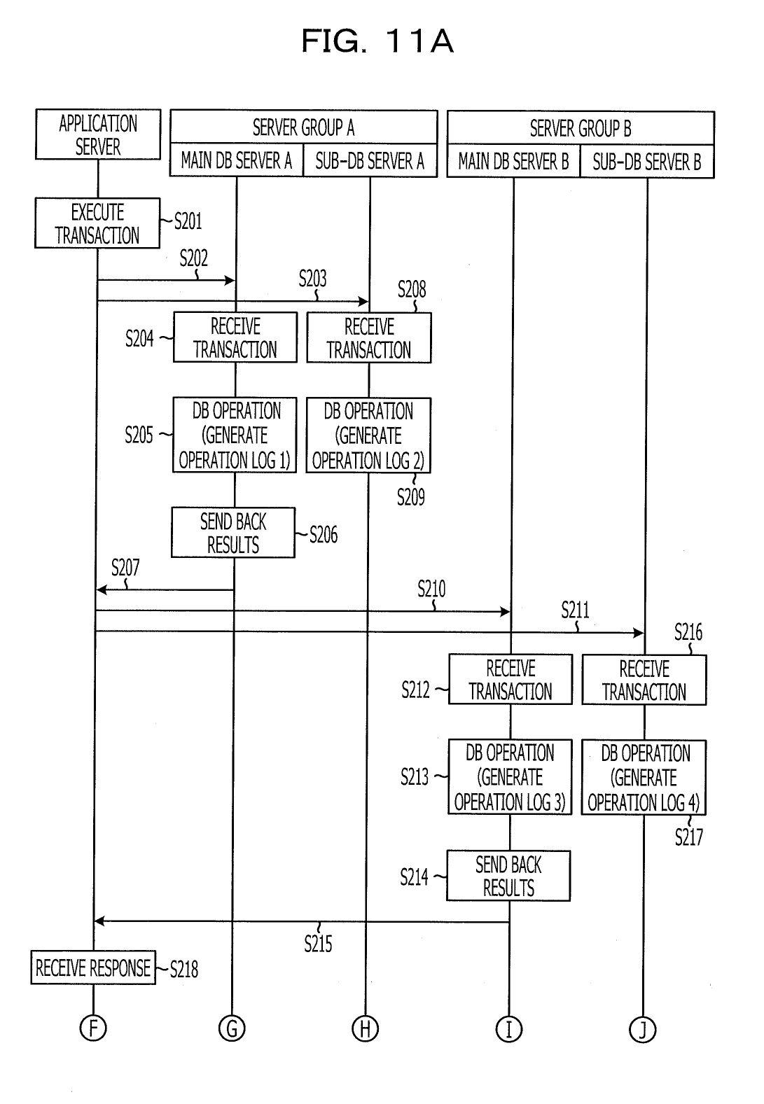

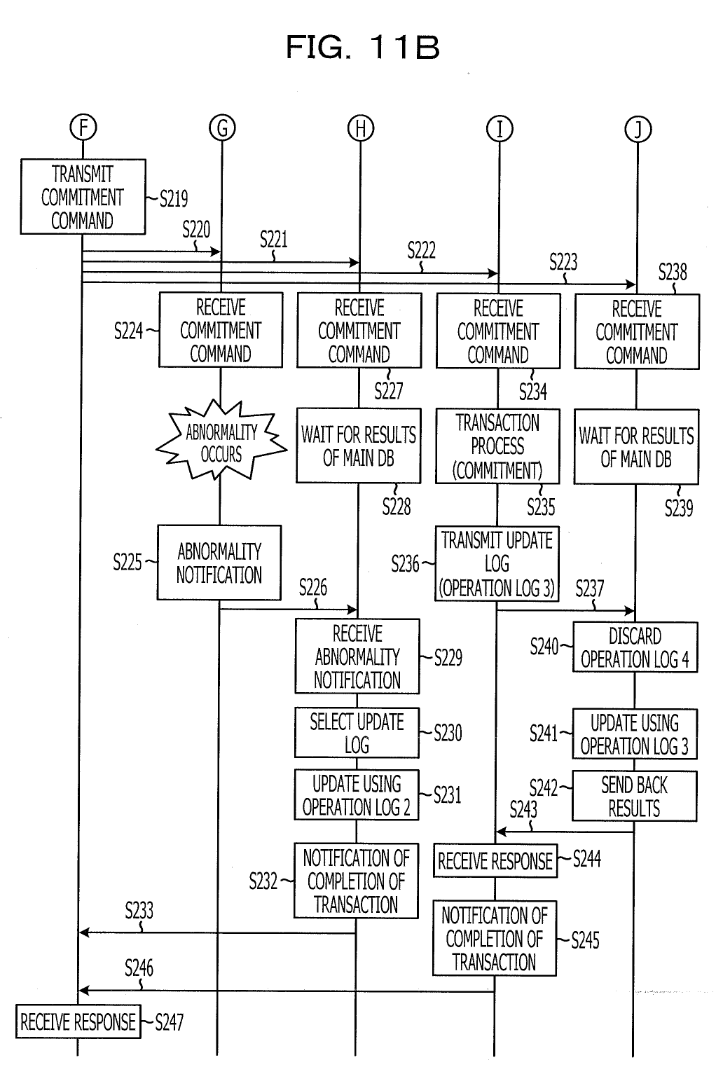

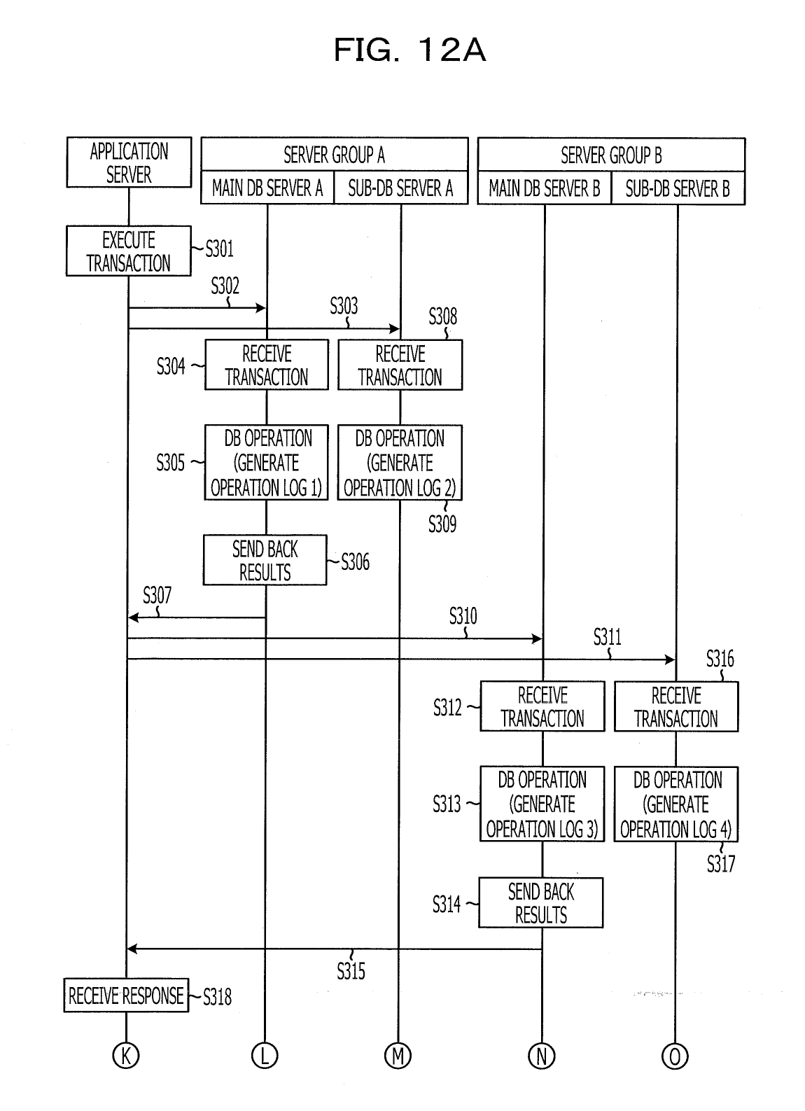

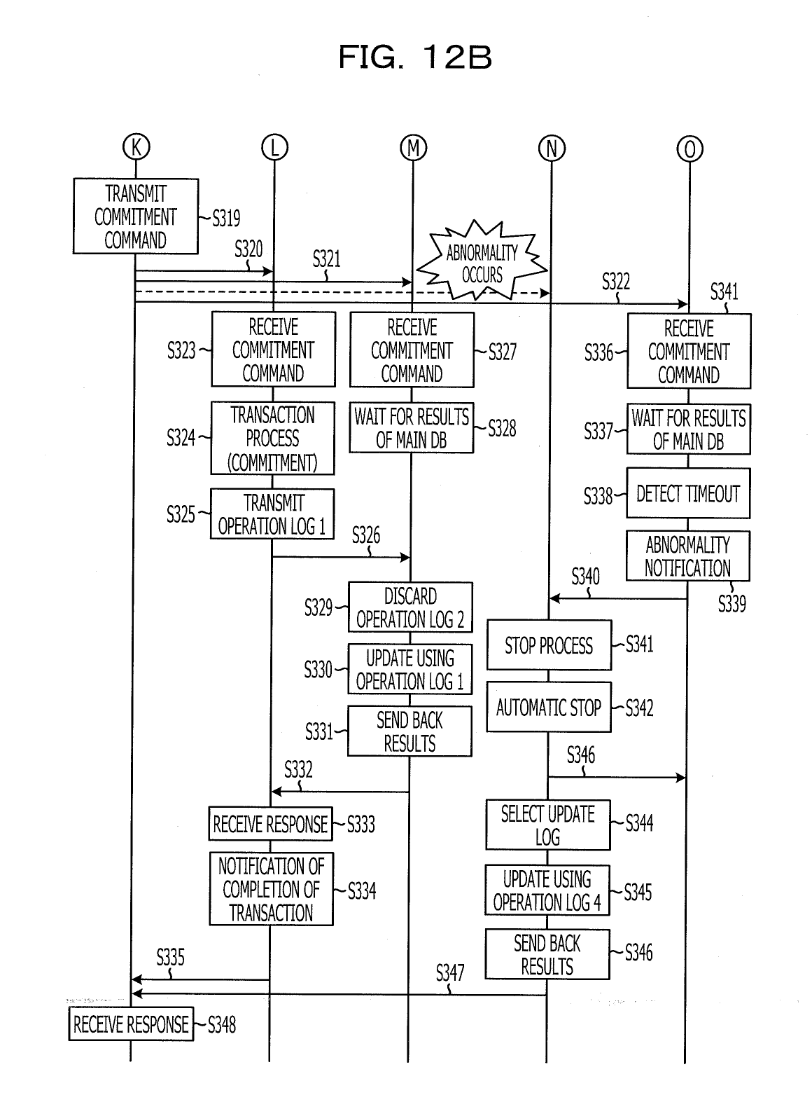

Next, with reference to FIGS. 10A to 13, the flow of processing executed by a database system according to the second embodiment will be described. FIGS. 10A and 10B are sequence diagrams illustrating the flow of a commitment process according to the second embodiment. FIGS. 11A and 11B are sequence diagrams illustrating the flow of processing at a time when an abnormality has occurred during the commitment process. FIGS. 12A and 12B are sequence diagrams illustrating the flow of a commitment process according to the second embodiment at a time when a communication abnormality has occurred.

Here, an example will be described in which the application server 10 transmits an operation command and a commitment command to Server Group A that includes a main DB server A and a sub-DB server A and Server Group B that includes a main DB server B and a sub-DB server B. The main DB servers and the sub-DB servers to be described here have the configuration illustrated in FIG. 4.

Flow of Commitment Process

As illustrated in FIGS. 10A and 10B, the application execution section 15a of the application server 10 executes an application read from the storage unit 14 in order to execute distributed transactions (S101). The operation command transmission section 15b issues a transaction to the main DB server A and the sub-DB server A in Server Group A (S102 and S103).

Next, a command execution section 33 of the main DB server A receives the transaction and stores the transaction in an operation command storage unit 26 (S104). In addition, the command execution section 33 of the main DB server A executes the received transaction and stores an operation log 1, which is a result of the execution, in an operation result log storage unit 27 (S105). Thereafter, the command execution section 33 of the main DB server A notifies the application server 10 of the execution of the received transaction (S106 and S107).

Meanwhile, in the sub-DB server A, too, a command execution section 33 of the sub-DB server A receives the transaction and stores the transaction in an operation command storage unit 26 (S108). The command execution section 33 of the sub-DB server A executes the received transaction and stores an operation log 2, which is a result of the execution, in an operation result log storage unit 27 (S109).

Next, the operation command transmission section 15b issues a transaction to the main DB server B and the sub-DB server B in Server Group B (S110 and S111). A command execution section 33 of the main DB server B receives the transaction and stores the transaction in an operation command storage unit 26 (S112). In addition, the command execution section 33 of the main DB server B executes the received transaction and stores an operation log 3, which is a result of the execution, in an operation result log storage unit 27 (S113). Thereafter, the command execution section 33 of the main DB server B notifies the application server 10 of the execution of the received transaction (S114 and S115).

Meanwhile, in the sub-DB server B, too, a command execution section 33 of the sub-DB server B receives the transaction and stores the transaction in an operation command storage unit 26 (S116). The command execution section 33 of the sub-DB server B executes the received transaction and stores an operation log 4, which is a result of the execution, in an operation result log storage unit 27 (S117).

Upon being notified of the execution of the transaction from the main DB server A and the main DB server B, the commitment command transmission section 15c of the application server 10 transmits a commitment command using multicast (S118 to S123).

That is, upon being notified of the execution of the transaction the number of times corresponding to the number of main DB servers, the commitment command transmission section 15c transmits the commitment command for the transaction to the main DB server A, the sub-DB server A, the main DB server B, and the sub-DB server B.

Next, a commitment section 34 of the main DB server A receives the commitment command (S124) and executes a transaction process (S125). That is, the commitment section 34 updates data of the storage unit 24 with the operation log 1 generated in S105 and determines the transaction. Thereafter, the commitment section 34 transmits the operation log 1 generated in S105 to the sub-DB server A as an update log (S126 and S127).

Meanwhile, a commitment section 34 of the sub-DB server A receives the commitment command (S128) and waits for results of the commitment process executed by the main DB server A (S129). Upon receiving the update log, the commitment section 34 of the sub-DB server A discards the operation log 2 generated in S109 (S130). The commitment section 34 then updates the storage unit 24 of the server that includes the commitment section 34 with the update log (operation log 1) received from the main DB server A and determines the transaction (S131). Thereafter, the result notification section 35 notifies the main DB server A of the update using the data (S132).

Upon being notified of the update using the results of the execution from each DB server, a result notification section 35 of the main DB server A notifies the application server 10 of completion of the commitment process in order to notify the application server 10 of completion of the transaction (S133 to S136).

In addition, in Server Group B, too, a commitment section 34 of the main DB server B receives the commitment command (S137) and executes a transaction process (S138). That is, the commitment section 34 updates data of the storage unit 24 with the operation log 3 generated in S113 and determines the transaction. Thereafter, the commitment section 34 transmits the operation log 3 generated in S113 to the sub-DB server B as an update log (S139 and S140).

Meanwhile, a commitment section 34 of the sub-DB server B receives the commitment command (S141) and waits for results of the commitment process executed by the main DB server B (S142). Upon receiving the update log, the commitment section 34 of the sub-DB server B discards the operation log 4 generated in S117 (S143). The commitment section 34 then updates the storage unit 24 of the server that includes the commitment section 34 with the update log (operation log 3) received from the main DB server B and determines the transaction (S144). Thereafter, the result notification section 35 notifies the main DB server B of the update using the data (S145).

Upon being notified of the update using the results of execution from each sub-DB server, a result notification section 35 of the main DB server B notifies the application server 10 of completion of the commitment process in order to notify the application server 10 of completion of the transaction (S146 to S149).

Thus, upon receiving the notification of the completion of the commitment process from both Server Group A and Server Group B, the application server 10 terminates the execution of the distributed transactions (S150).

Flow when Abnormality has Occurred During Commitment Process

Next, the flow when an abnormality has occurred during the commitment process will be described with reference to FIGS. 11A and 11B. Processing executed in S201 to S223 illustrated in FIGS. 11A and 11B is the same as that executed in S101 to S123 illustrated in FIGS. 10A and 10B, and therefore description thereof is omitted here.

After receiving the commitment command (S224), the commitment section 34 of the main DB server A detects occurrence of an abnormality such as, for example, an abnormality in hardware. The commitment section 34 then transmits an abnormality notification indicating that an abnormality has occurred in the main DB server A to the sub-DB server A (S225 and S226).

Meanwhile, the commitment section 34 of the sub-DB server A receives a commitment command (S227) and waits for results of the commitment process executed by the main DB server A (S228). Thereafter, the commitment section 34 of the sub-DB server A receives the abnormality notification from the main DB server A (S229). The commitment section 34 then selects an update log (S230). That is, the commitment section 34 updates the storage unit 24 of the server that includes the commitment section 34 with the operation log 2 generated in S209 and determines the transaction (S231). Thereafter, the result notification section 35 notifies application server 10 of the update using the data (S232 and S233).

If an operation log of another application exists for a commitment target record when an update log is selected, the sub-DB server A executes operations again on the latest data in view of operations that have not been completed except for the commitment process. Because the operations that have not been completed can be judged to be in an exclusion wait state by the operation of an application that has requested to execute the commitment process, the exclusion wait state is canceled, if possible.

Processing executed in S234 to S246 illustrated in FIG. 11B is the same as that executed in S137 to S149 illustrated in FIG. 10B, and therefore description thereof is omitted here.

Thus, even if an abnormality has occurred in the main DB server A, the application server 10 receives the notification of completion of the commitment process from both Server Group A and Server Group B and terminates the execution of the distributed transactions (S247).

Flow when Communication Abnormality has Occurred

Next, the flow when a communication abnormality has occurred will be described with reference to FIGS. 12A and 12B. Processing executed in S301 to S319 illustrated in FIGS. 12A and 12B is the same as that executed in S101 to S119 illustrated in FIGS. 10A and 10B, and therefore description thereof is omitted here. Similarly, processing executed in S320 and S321 illustrated in FIG. 12B is the same as that executed in S120 and S121 illustrated in FIG. 10B, and therefore description thereof is omitted here. Similarly, processing executed in S322 to S335 illustrated in FIG. 12B is the same as that executed in S123 to S136 illustrated in FIG. 10B, and therefore description thereof is omitted here.

In the case of FIGS. 12A and 12B, a commitment command transmitted from the commitment command transmission section 15c of the application server 10 using multicast does not reach the main DB server B due to a communication abnormality between the main DB server B and the application server 10.

In this case, the commitment section 34 of the sub-DB server receives the commitment command (S336) and waits for results of the commitment process executed by the main DB server B (S337). Thereafter, if a certain period of time has elapsed since S336 without receiving an update log or an abnormality notification from the main DB server, the commitment section 34 of the sub-DB server B detects timeout (S338). The commitment section 34 then transmits an abnormality notification to the main DB server B (S339).

Upon receiving the abnormality notification, the result notification section 35 of the main DB server B terminates various processes that have been executed thereby as a database system, such as making a backup (S341). The result notification section 35 of the main DB server B then automatically stops (S342) and notifies the sub-DB server B of the stop of the system (S343). The order in which the processing is executed in S340 to S346 is not limited to this, and may be changed arbitrarily.

Thereafter, the commitment section 34 of the sub-DB server B selects an update log (S344). That is, the commitment section 34 updates the storage unit 24 of the server that includes the commitment section 34 with the operation log 4 generated in S317 and determines the transaction (S345). Thereafter, the result notification section 35 notifies the application server 10 of the update using the data (S346 and S347).

Thus, even if a communication abnormality has occurred in the main DB server B, the application server 10 receives the notification of completion of the commitment process from both Server Group A and Server Group B and terminates the execution of the distributed transactions (S348).

Advantageous Effects Produced by Second Embodiment

Thus, according to the second embodiment, even if a transaction included in distributed transactions fails due to a network abnormality or a server abnormality, processing is continued by a spare database to complete the transaction. Therefore, a user need not execute the distributed transactions again. Furthermore, it is possible to prevent a database from entering the in-doubt state and to hide a DB server crash from the application. In addition, by using the configuration that includes main and sub-DB servers, the availability of the system is improved through the process for copying data. In addition, since a sub-DB server is automatically promoted to a main DB server when an abnormality has occurred in a main DB server, even if an abnormality has occurred in a main DB server, adverse effects caused by the abnormality on the entire system can be reduced without stopping the system. Furthermore, since it is possible to automatically update the promotion order, the performance of the system can be improved. In addition, it is possible to improve the performance of the commitment process.

In addition, unlike the general two-phase commitment control, the number of communications executed for each distributed transaction is the same as that for a commitment process executed for a transaction that is not distributed to a plurality of servers, thereby simplifying the control method and improving the performance. In addition, since the performance of a commitment determination process in distributed transactions is improved, it is possible to prevent a database from entering the in-doubt state.

Flow of Processing in Two-Phase Commitment Control

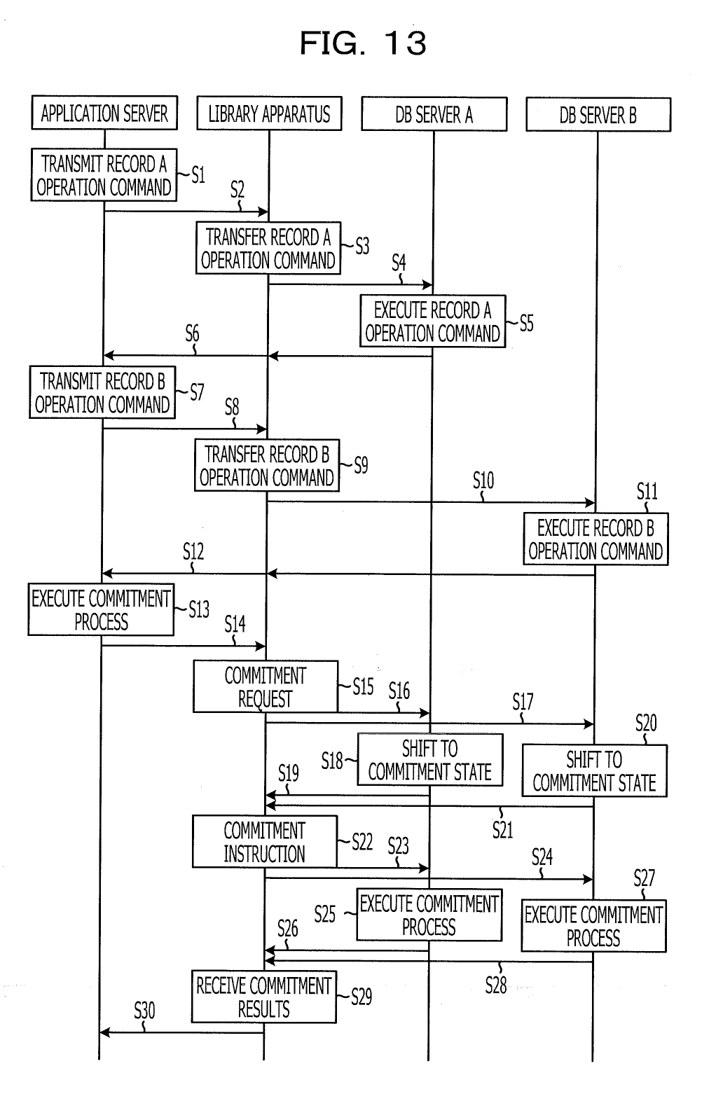

Now, the general two-phase commitment control will be briefly described with reference to FIG. 13. FIG. 13 is a sequence diagram illustrating the flow of processing in the two-phase commitment control. As illustrated in FIG. 13, an application server transmits an operation command of Record A to a library apparatus (S1 and S2). The library apparatus transfers Record A to a DB server A, which has Record A (S3 and S4). Thereafter, the library apparatus receives results of execution from the DB server A and sends the results back to the application server (S5 and S6).

Similarly, the application server transmits an operation command of Record B to the library apparatus (S7 and S8). The library apparatus transfers Record B to a DB server B, which has Record B (S9 and S10). Thereafter, the library apparatus receives results of execution from the DB server B and sends the results back to the application server (S11 and S12).

Thereafter, the application server transmits, to the library apparatus, an instruction for executing a commitment process on transactions in which Records A and B have been updated (S13 and S14). Next, the library apparatus transmits a commitment request to the DB server A and the DB server B in order to shift the DB server A and the DB server B to a commitment stand-by state (S15 to S21). Thereafter, upon being notified of the transition to the commitment stand-by state from the DB servers A and B, the library apparatus transmits a commitment instruction to the DB servers A and B (S22 to S24). Next, the DB server A and the DB server B execute a commitment process and transmit results of the commitment process to the library apparatus (S25 to S28). Upon receiving the results of the commitment process from the DB servers A and B, the library apparatus notifies the application server of termination of the commitment process (S29 and S30).

Results of Comparison

Thus, in the second embodiment illustrated in FIGS. 10A and 10B, the number of communications executed for each distributed transaction is smaller than in the case illustrated in FIG. 13. That is, the number of communication processes executed to determine the commitment process for each distributed transaction is reduced, thereby improving the performance. In addition, in the case of FIG. 13, because the library apparatus, which is a transaction manager, is a single point of failure, if an abnormality occurs in a manager having transaction information, the locked state between a plurality of servers might not be canceled. In the second embodiment, this can be prevented.

### Third Embodiment

Embodiments have been described above, but the present invention may be implemented in various different modes other than the above-described embodiments. Another embodiment will be described hereinafter.

Application to Other Types of Servers

Although an example in which the present invention is applied to a database system including an application server and database servers has been described in the first and second embodiments, the present invention is not limited to this example. For example, instead of the application server, a computer-aided design (CAD) apparatus that designs an electronic circuit and the like may be used and, instead of the database servers, generation apparatuses that receive instructions from the CAD apparatus and that actually generate substrates and the like may be used. That is, the one-phase commitment control method that has been described in the first and second embodiments may be applied to various systems that are currently managed using the two-phase commitment control method.

Activity Check

For example, although an example in which the activity of each apparatus connected to a certain apparatus is checked has been described in the second embodiment, the present invention is not limited to this example. For example, each DB server may refer to a main-sub relationship storage unit and check the activity of DB servers that are set to be earlier or later than the DB server in the main-sub promotion order.

System

In addition, among the processes described in the above embodiments, some or all of the processes described as processes to be executed automatically may be executed manually. In addition, some or all of the processes described as processes to be executed manually may be executed automatically using known methods. Furthermore, the processing procedures, the control procedures, the specific names, and the information including, for example, various pieces of data and parameters illustrated in FIGS. 3, 5 to 9, and the like may be arbitrarily changed unless otherwise specified.

In addition, the components of each apparatus illustrated in the drawings are conceptualized in terms of the functions and therefore need not be physically configured as illustrated in the drawings. That is, specific forms of distribution and integration of each apparatus are not limited to those illustrated in the drawings. For example, each apparatus may be configured by functionally or physically distributing or integrating some or all of the components thereof in a certain unit in accordance with various types of loads or usage, such as by integrating the command execution section 33 and the commitment section 34. Furthermore, the entirety or part of each processing function to be executed by each apparatus can be realized by a CPU or a program that is analyzed and executed by the CPU.

Programs

The processes described in the above embodiments may be realized by executing programs prepared in advance on a computer system such as a personal computer or a work station. An example of the computer system that executes programs having the same functions as the above embodiments will be described hereinafter.

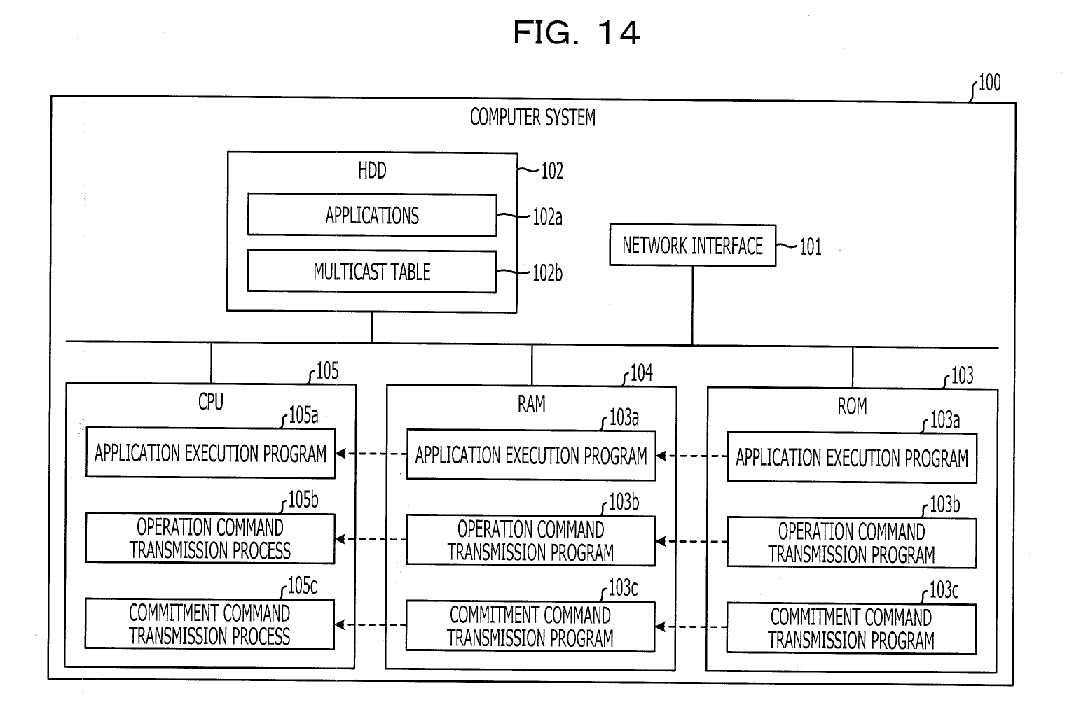

FIG. 14 is a diagram illustrating an example of a computer system that executes application server control programs. As illustrated in FIG. 14, a computer system 100 has a network interface 101, a hard disk drive (HDD) 102, a read-only memory (ROM) 103, a random-access memory (RAM) 104, and a CPU 105 through a bus. The network interface 101 corresponds to the communication control I/F unit 11 illustrated in FIG. 2.

In addition, the programs having the same functions as the above embodiments are stored in the ROM 103 in advance. That is, as illustrated in FIG. 14, an application execution program 103a, an operation command transmission program 103b, and a commitment command transmission program 103c are stored in the ROM 103 in advance.

The CPU 105 reads the application execution program 103a, the operation command transmission program 103b, and the commitment command transmission program 103c and expands the application execution program 103a, the operation command transmission program 103b, and the commitment command transmission program 103c to the RAM 104. That is, the CPU 105 executes the application execution program 103a as an application execution process 105a. In addition, the CPU 105 executes the operation command transmission program 103b as an operation command transmission process 105b. In addition, the CPU 105 executes the commitment command transmission program 103c as a commitment command transmission process 105c.

The application execution process 105a corresponds to the application execution section 15a illustrated in FIG. 2. In addition, the operation command transmission process 105b corresponds to the operation command transmission section 15b. In addition, the commitment command transmission process 105c corresponds to the commitment command transmission section 15c. In addition, the HDD 102 is provided with applications 102a and a multicast table 102b corresponding to the applications 14a and the multicast storage section 14b, respectively, illustrated in FIG. 2.

The above-described programs 103a to 103c need not necessarily be stored in the ROM 103. For example, the above-described programs 103a to 103c may be stored in a portable physical medium to be inserted into the computer system 100, such as a flexible disk (FD), a compact disc read-only memory (CD-ROM), a magneto-optical (MO) disk, a digital versatile disc (DVD), or an integrated circuit (IC) card. Alternatively, the above-described programs 103a to 103c may be stored in a fixed physical medium provided inside or outside the computer system 100, such as an HDD. Alternatively, the above-described programs 103a to 103c may be stored in another computer system connected to the computer system 100 through a public line, the Internet, a LAN, a wide area network (WAN), or the like. The computer system 100 may read the programs 103a to 103c from such a network and execute the programs 103a to 103c.

That is, these programs are to be stored in a recording medium such as the portable physical medium, the fixed physical medium, or the communication medium described above in such a way as to enable the computer system 100 to read the programs. The computer system 100 reads the programs 103a to 103c from such a recording medium and executes the programs 103a to 103c in order to realize the functions that are the same as the above embodiments. It is to be noted that the programs described in this embodiment are not limited to ones to be executed by the computer system 100. For example, the present invention may also be applied to a case in which another computer system or a server executes the programs and a case in which another computer system and a server together execute the programs.

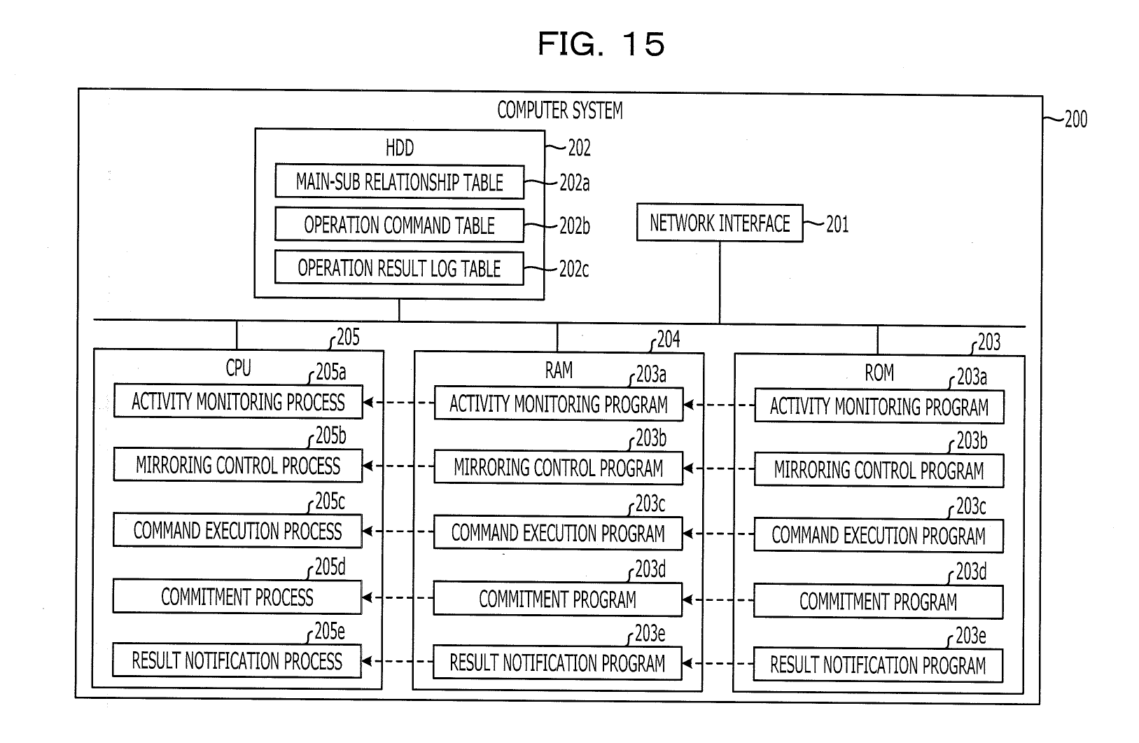

FIG. 15 is a diagram illustrating an example of a computer system that executes database server control programs. As illustrated in FIG. 15, a computer system 200 has a network interface 201, an HDD 202, a ROM 203, a RAM 204, and a CPU 205 through a bus. The network interface 201 corresponds to the communication control I/F unit 21 illustrated in FIG. 4.

In addition, programs having the same functions as the above embodiments are stored in the ROM 203 in advance. That is, as illustrated in FIG. 15, an activity monitoring program 203a, a mirroring control program 203b, a command execution program 203c, a commitment program 203d, and a result notification program 203e are stored in the ROM 203 in advance.

The CPU 205 reads the programs 203a to 203e and expands the programs 203a to 203e to the RAM 204. That is, the CPU 205 executes the activity monitoring program 203a as an activity monitoring process 205a. In addition, the CPU 205 executes the mirroring control program 203b as a mirroring control process 205b. In addition, the CPU 205 executes the command execution program 203c as a command execution process 205c. In addition, the CPU 205 executes the commitment program 203d as a commitment process 205d. In addition, the CPU 205 executes the result notification program 203e as a result notification process 205e.

The activity monitoring process 205a corresponds to the activity monitoring section 31 illustrated in FIG. 4. In addition, the mirroring control process 205b corresponds to the mirroring control section 32. In addition, the command execution process 205c corresponds to the command execution section 33. In addition, the commitment process 205d corresponds to the commitment section 34. In addition, the result notification process 205e corresponds to the result notification section 35.

In addition, the HDD 202 is provided with a main-sub relationship table 202a corresponding to the main-sub relationship storage unit 25 illustrated in FIG. 4. The HDD 202 is also provided with an operation command table 202b corresponding to the operation command storage unit 26. The HDD 202 is also provided with an operation result log table 202c corresponding to the operation result log storage unit 27.

The above-described programs 203a to 203e need not necessarily be stored in the ROM 203. For example, the above-described programs 203a to 203e may be stored in a portable physical medium to be inserted into the computer system 200, such as an FD, a CD-ROM, an MO disk, a DVD, or an IC card. Alternatively, the above-described programs 203a to 203e may be stored in a fixed physical medium provided inside or outside the computer system 200, such as an HDD. Alternatively, the above-described programs 203a to 203e may be stored in another computer system connected to the computer system 200 through a public line, the Internet, a LAN, a WAN, or the like. The computer system 200 may read the programs 203a to 203e from such a network and execute the programs 203a to 203e.

That is, these programs are to be stored in a recording medium such as the portable physical medium, the fixed physical medium, or the communication medium described above in such a way as to enable the computer system 200 to read the programs. The computer system 200 reads the programs 203a to 203e from such a recording medium and executes the programs 203a to 203e in order to realize the functions that are the same as the above embodiments. It is to be noted that the programs described in this embodiment are not limited to ones to be executed by the computer system 200. For example, the present invention may also be applied to a case in which another computer system or a server executes the programs and a case in which another computer system and a server together execute the programs.

As mentioned above, the present invention has been specifically described for better understanding of the embodiments thereof and the above description does not limit other aspects of the invention. Therefore, the present invention can be altered and modified in a variety of ways without departing from the gist and scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus comprising:
an execution response unit that, upon receiving an operation command from a process execution apparatus that executes various processes, executes the operation command and that sends results of the execution back to the process execution apparatus;
a first result update unit that, upon receiving a determination command for determining the operation command when the information processing apparatus is operating normally, updates the information processing apparatus with the results of the execution sent by the execution response unit and that transmits the results of the execution to copy apparatuses obtained by copying the information processing apparatus;
a second result update unit that, upon receiving the determination command transmitted from the process execution apparatus when operation of the information processing apparatus is abnormal, transmits an abnormality notification indicating that the operation of the information processing apparatus is abnormal to the copy apparatuses; and
a determination transmission unit that, upon being notified of the update using the results of the execution from the copy apparatuses that have received the results of the execution transmitted from the first result update unit, notifies the process execution apparatus of the determination of the operation command.

2. The information processing apparatus according to claim 1,
wherein, upon being notified, from the copy apparatuses, of an abnormal state in which the determination command cannot be received from the process execution apparatus, the determination transmission unit stops the information processing apparatus.

3. The information processing apparatus according to claim 1, further comprising:
a promotion order storage unit that, when an abnormality has occurred in the information processing apparatus, stores a promotion order in which the copy apparatuses are promoted to a position of the information processing apparatus, which is an apparatus from which the copy apparatuses have been copied,
wherein the second result update unit transmits the abnormality notification to a copy apparatus that is next to be promoted to the position of the apparatus from which the copy apparatuses have been copied in accordance with the promotion order stored in the promotion order storage unit.

4. An information processing apparatus comprising:
a result generation unit that, upon receiving an operation command from a process execution apparatus that executes various processes, executes the operation command and generates results of the execution;
a first result update unit that, upon receiving results of execution generated by an apparatus from which the information processing apparatus has been copied, discards the results of the execution generated by the result generation unit and that updates the information processing apparatus with the received results of the execution;
a second result update unit that, upon receiving, from the apparatus from which the information processing apparatus has been copied, an abnormality notification indicating that operation of the apparatus from which the information processing apparatus has been copied is abnormal, updates the information processing apparatus with the results of the execution generated by the result generation unit;
a first result notification unit that, when the first result update unit has updated the information processing apparatus with the results of the execution, notifies the apparatus from which the information processing apparatus has been copied of the update with the results of the execution; and
a second result notification unit that, when the second result update unit has updated the information processing apparatus using the results of the execution, notifies the process execution apparatus of the update using the results of the execution.

5. The information processing apparatus according to claim 4,
wherein, upon detecting an abnormality in the apparatus from which the information processing apparatus has been copied, the second result update unit notifies the apparatus from which the information processing apparatus has been copied of occurrence of the abnormality and updates the information processing apparatus with the results of the execution generated by the result generation unit.

6. The information processing apparatus according to claim 4, further comprising:
a promotion order storage unit that stores a promotion order in which copy apparatuses are promoted to a position of the apparatus from which the information processing apparatus has been copied;
a judgment unit that, when it has been detected that operation of the apparatus from which the information processing apparatus has been copied is abnormal, judges whether or not the information processing apparatus is to be promoted to the position of the apparatus from which the information processing apparatus has been copied in accordance with the promotion order stored in the promotion order storage unit; and
a promotion unit that, if it has been judged by the judgment unit that the information processing unit is to be promoted to the position of the apparatus from which the information processing apparatus has been copied, promotes the information processing apparatus to the position of the apparatus from which the information processing apparatus has been copied.

7. A database system comprising:
an application server;
an original database server; and
a copy database server obtained by copying the original database server,
wherein the application server includes
an operation command transmission unit that transmits, to the original database server and the copy database server, an operation command for databases using multicast, and
a determination command transmission unit that, when the operation command transmitted by the operation command transmission unit is to be determined, transmits, to the original database server and the copy database server, a determination command for determining the operation command using multicast,
wherein the original database server includes
an execution response unit that, upon receiving the operation command from the application server, executes the operation command and that sends results of the execution back to the application server,
a first results update unit that, upon receiving the determination command transmitted from the application server when the original database server is operating normally, updates the original database server with the results of the execution sent by the execution response unit and that transmits the results of the execution to the copy database server,
a second result update unit that, upon receiving the determination command transmitted from the application server when operation of the original database server is abnormal, transmits an abnormal notification indicating that the operation of the original database server is abnormal to the copy database server, and
a determination transmission unit that, upon being notified of the update using the results of the execution from the copy database server that has received the results of the execution transmitted from the first result update unit, notifies the application server of the determination of the operation command, and
wherein the copy database server includes
a result generation unit that, upon receiving the operation command from the application server, executes the operation command and that generates results of the execution,
a first result update unit that, upon receiving the results of the execution from the original database server, discards the results of the execution generated by the result generation unit and that updates the copy database server with the received results of the execution,
a second result update unit that, upon receiving the abnormality notification from the original database server, updates the copy database server with the results of the execution generated by the result generation unit,
a first result notification unit that, when the first result update unit has updated the copy database server with the results of the execution, notifies the original database server of the update using the results of the execution, and
a second result notification unit that, when the second result update unit has updated the copy database server with the results of the execution, notifies the application server of the update using the results of the execution.

8. The database system according to claim 7,
wherein the copy database server further includes
a promotion unit that, when the second result notification unit has notified the application server of the update using the results of the execution, promotes the copy database server to a position of the original database server.

9. A method of controlling an information processing apparatus comprising:
upon receiving an operation command from a process execution apparatus that executes various processes, executing the operation command and sending results of the execution back to the process execution apparatus by the information processing apparatus;
upon receiving a determination command for determining the operation command when the information processing apparatus is operating normally, updating the information processing apparatus with the results of the execution and transmitting the results of the execution to copy apparatuses obtained by copying the information processing apparatus;
upon receiving the determination command transmitted from the process execution apparatus when operation of the information processing apparatus is abnormal, transmitting an abnormality notification indicating that the operation of the information processing apparatus is abnormal to the copy apparatuses; and
upon being notified of the update using the results of the execution from the copy apparatuses that have received the results of the execution, notifying the process execution apparatus of the determination of the operation command.

10. A method of an information processing apparatus comprising:
upon receiving an operation command from a process execution apparatus that executes various processes, executing the operation command and generating results of the execution by the information processing apparatus;
upon receiving results of execution generated by an apparatus from which the information processing apparatus has been copied, discarding the results of the execution and updating the information processing apparatus with the received results of the execution;
upon receiving, from the apparatus from which the information processing apparatus has been copied, an abnormality notification indicating that operation of the apparatus from which the information processing apparatus has been copied is abnormal, updating the information processing apparatus with the results of the execution;
when having updated the information processing apparatus with the results of the execution, notifying the apparatus from which the information processing apparatus has been copied of the update with the results of the execution; and
when having updated the information processing apparatus using the results of the execution, notifying the process execution apparatus of the update using the results of the execution.

11. An information processing apparatus comprising:
a processor; and
a storage,
wherein the processor
upon receiving an operation command from a process execution apparatus that executes various processes, executes the operation command and sends results of the execution back to the process execution apparatus,
upon receiving a determination command for determining the operation command when the information processing apparatus is operating normally, updates the information processing apparatus with the results of the execution and transmits the results of the execution to copy apparatuses obtained by copying the information processing apparatus,
upon receiving the determination command transmitted from the process execution apparatus when operation of the information processing apparatus is abnormal, transmits an abnormality notification indicating that the operation of the information processing apparatus is abnormal to the copy apparatuses, and
upon being notified of the update using the results of the execution from the copy apparatuses that have received the results of the execution, notifies the process execution apparatus of the determination of the operation command.

12. An information processing apparatus comprising:
a processor; and
a storage,
wherein the processor
upon receiving an operation command from a process execution apparatus that executes various processes, executes the operation command and generates results of the execution,
upon receiving results of execution generated by an apparatus from which the information processing apparatus has been copied, discards the results of the execution generated by the result generation unit and updates the information processing apparatus with the received results of the execution,
upon receiving, from the apparatus from which the information processing apparatus has been copied, an abnormality notification indicating that operation of the apparatus from which the information processing apparatus has been copied is abnormal, updates the information processing apparatus with the results of the execution,
when having updated the information processing apparatus with the results of the execution, notifies the apparatus from which the information processing apparatus has been copied of the update with the results of the execution, and
when having updated the information processing apparatus using the results of the execution, notifies the process execution apparatus of the update using the results of the execution.
